(19) United States
(12) Patent Application Publication
(10) Pub. No.: US 2020/0143188 A1
(43) Pub. Date: May 7, 2020

(54) IDENTIFICATION SYSTEM AND IDENTIFICATION APPARATUS

(71) Applicant: FUJI XEROX CO., LTD., Tokyo (JP)

(72) Inventors: Kensuke ITO, Kanagawa (JP); Eisaku HAYASHI, Kanagawa (JP)

(73) Assignee: FUJI XEROX CO., LTD., Tokyo (JP)

(21) Appl. No.: 16/666,419

(22) Filed: Oct. 29, 2019

(30) Foreign Application Priority Data
Nov. 6, 2018 (JP) 2018-208989

(51) Int. Cl. G06K 9/00

(52) U.S. Cl. CPC G06K 9/00926; G06K 9/00067; G06K 9/00892; G06K 2009/00932; G06K 9/00617; G06K 9/00087; G06K 9/0061

(57) ABSTRACT

An identification system includes a first imaging apparatus that captures a first image including an object to be identified, a second imaging apparatus that captures a second image finer than the first image and including an object to be identified, and an identification apparatus that identifies an object by use of the first image and the second image. The identification apparatus includes an acquirer and a storage controller. The acquirer acquires first identification data and second identification data. The first identification data is feature data acquired from the first image and representing a feature distributed on a surface of the object. The second identification data is feature data acquired from the second image and representing a feature distributed on a surface of the object. The storage controller causes the first identification data and the second identification data acquired by the acquirer to be stored in association with each other.

### CROSS-REFERENCE TO RELATED APPLICATIONS

This application is based on and claims priority under 35 USC 119 from Japanese Patent Application No. 2018-208989 filed Nov. 6, 2018.

### BACKGROUND

### (i) Technical Field

The present disclosure relates to an identification system and an identification apparatus.

### (ii) Related Art

Japanese Unexamined Patent Application Publication No. 2004-171109 describes a device authentication system including a device to be authenticated (to be referred to as “authenticated device” hereinafter) that has a random pattern, and a device authentication apparatus that acquires the random pattern of the authenticated device to authenticate the authenticity of the authenticated object. The authenticated device has so-called “lame” materials reflecting light and embedded in a base material that has high optical transparency. The device authentication apparatus includes a light source that irradiates the authenticated device with light, a random pattern reader that reads the random pattern of the authenticated device from an image of light reflected by the authenticated device, a first data acquirer that acquires first ID data unique to the authenticated device from the random pattern read by the random pattern reader, a second data recorder that records second ID data, which is used for the purpose of verification to determine the authenticity of the first ID data, a second data acquirer that acquires the second ID data recorded in the second data recorder, and a relevance calculator that calculates the relevance between the first ID data and the second ID data to authenticate the authenticity of the authenticated device.

Various objects such as paper, tablets, metals, and resin often have, for example, unique feature data such as a random pattern distributed on their surface, as with human fingerprints, venous patterns, and iris patterns. Accordingly, an identification technique described below has been proposed. According to such a technique, feature data distributed on the surface of an object is registered in advance as data used for registration (to be referred to as “registration data” hereinafter). When feature data is acquired from the surface of an object again, the acquired feature data, which serves as data used for identification (to be referred to as “identification data” hereinafter), is compared with the registration data to thereby identify whether the object from which the identification data has been acquired is identical to the object from which the registration data has been acquired.

With the above-mentioned technique, if the identification data matches the registration data, the object from which the identification data has been acquired is recognized to be the object from which the registration data has been acquired.

Generally, if the fineness of identification data is lower than the fineness of registration data, it may not be possible in some cases to determine that the two pieces of data match, even though these pieces of data have been acquired from the same object.

### SUMMARY

Aspects of non-limiting embodiments of the present disclosure relate to an identification system with which, even if multiple pieces of identification data with different degrees of fineness are used, it is possible to identify whether an object from which each piece of identification data has been acquired is identical to an object from which registration data has been acquired.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an identification system including a first imaging apparatus that captures a first image including an object to be identified, a second imaging apparatus that captures a second image including an object to be identified, the second image being finer than the first image, and an identification apparatus that identifies an object by use of the first image and the second image. The identification apparatus includes an acquirer, and a storage controller. The acquirer acquires first identification data and second identification data. The first identification data is feature data representing a feature distributed on a surface of the object. The first identification data is acquired from the first image captured by the first imaging apparatus. The second identification data is feature data representing a feature distributed on a surface of the object. The second identification data is acquired from the second image captured by the second imaging apparatus. The storage controller causes the first identification data and the second identification data acquired by the acquirer to be stored in association with each other.

### BRIEF DESCRIPTION OF THE DRAWINGS

Exemplary embodiments of the present disclosure will be described in detail based on the following figures, wherein:

FIG. 1 illustrates a sheet of first paper representing an example of an object;

FIG. 2 is a cross-sectional view of a first example of an attachment piece;

FIG. 3 is a cross-sectional view of a second example of an attachment piece;

FIG. 4A illustrates a third example of an attachment piece;

FIG. 4B illustrates a first image representing a captured image of an attachment piece;

FIG. 4C illustrates a second image representing a captured image of an attachment piece;

FIG. 5 is a cross-sectional view of a fifth example of an attachment piece;

FIG. 6 is a block diagram illustrating a first exemplary configuration of a registration and identification system;

FIG. 7 is a flowchart illustrating a first mode of operation of a registration and identification system;

FIG. 8 is a flowchart illustrating a second mode of operation of a registration and identification system; and

FIG. 9 is a block diagram illustrating a second exemplary configuration of a registration and identification system.

### DETAILED DESCRIPTION

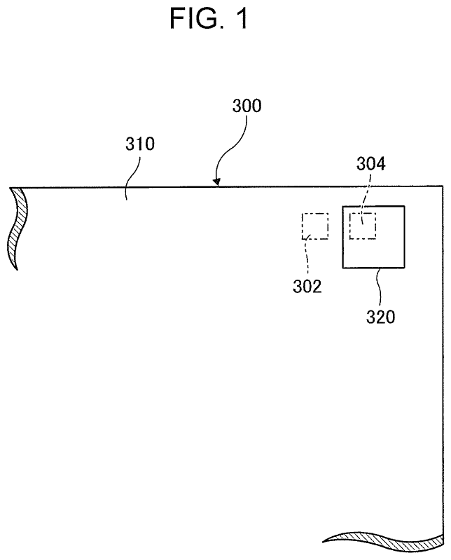

Exemplary embodiments of the present disclosure will be described below with reference to the drawings. FIG. 1 illustrates a sheet of paper 300 representing a first example of an object to be identified. As illustrated in FIG. 1, the paper 300 has a paper body 310, and an attachment piece 320. Examples of such attachment pieces 320 include pieces that are affixed like a sticker. The paper body 310 represents an example of a body part, and the attachment piece 320 represents an example of an attachment part attached on the body part. The surface of the attachment piece 320 is provided with a unique random pattern. That is, the random pattern and the object have a one-to-one correspondence such that identifying the random pattern makes it possible to identify a single object from which the random pattern has been acquired.

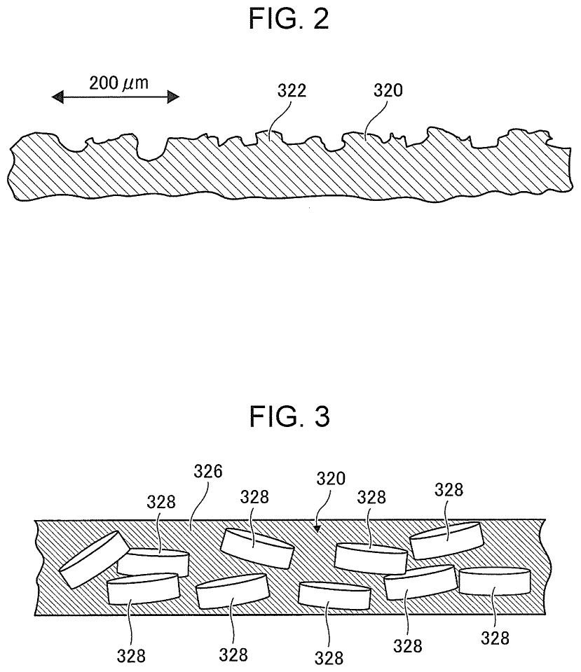

In the first example, a wood piece 322 is used as the attachment piece 320. As illustrated in the cross-sectional view of FIG. 2, the wood piece 322 has a three-dimensional structure whose surface defines a unique random pattern. In the present case, the random pattern, which is about 200 μm, is coarser than the random pattern formed by the fibers of the paper body 310, and can be imaged at a resolution of about 200 dpi.

An image of the random pattern on the surface of the wood piece 322 is captured by a first imaging apparatus 30 described later. The random pattern on the surface of the wood piece 322 represents an example of feature data distributed on the surface of the paper 300. The random pattern is acquired as first registration data described later and also as first identification data described later.

As described above, the wood piece 322 has a three-dimensional structure. This means that it is not possible to duplicate the three-dimensional structure by, for example, a method such as copying using an electrophotographic system. To duplicate the three-dimensional structure of the wood piece 322, it is necessary to make a mold of the three-dimensional structure and then form the three-dimensional structure, or use a three-dimensional printer to form the three-dimensional structure. Duplicating the three-dimensional structure is thus costly. Even if the three-dimensional structure is duplicated by making a mold, the duplicated wood piece differs from the wood piece 322 in color and material. This makes it easy to recognize the duplicated wood piece as a duplicate through visual inspection. As described above, the wood piece 322 is difficult to duplicate (counterfeit), and thus has high counterfeit-resistance.

The surface of the paper body 310 is provided with a random pattern formed by the irregularities of paper fibers. The random pattern is finer than the random pattern on the surface of the wood piece 322. An image of the random pattern is captured by a second imaging apparatus 32 described later. The random pattern formed by the irregularities of the fibers of the paper body 310 represents an example of feature data distributed on the surface of the paper 300. This random pattern is acquired as second registration data described later, and also acquired as second identification data described later.

The surface of the paper 300 includes a first imaging region 302, and a second imaging region 304. The first imaging region 302 is a region from which a first image is captured by the first imaging apparatus 30 described later. The first imaging region 302 is located on the surface of the paper body 310. The second imaging region 304 is a region from which a second image finer than the first image is captured by the second imaging apparatus 32 described later. The second imaging region 304 is present on the surface of the attachment piece 320.

An image of the first imaging region 302 is captured at a resolution of, for example, 200 dpi. An image of the second imaging region 304 is captured at a resolution of, for example, 800 dpi, which is higher than the resolution at which the image of the first imaging region is captured.

FIG. 3 illustrates a cross-section of a second example of the attachment piece 320, which is attached onto the paper 300 representing a second example of an object to be identified. Although the paper 300 according to the second example is also provided with the attachment piece 320 attached on the paper body 310 as with the first example mentioned above, the attachment piece 320 differs in configuration from the attachment piece 320 according to the first example.

In the second example, the attachment piece 320 includes, for example, glittering materials 328 made of metal pieces mixed into a base material 326 having optical transparency as illustrated in FIG. 3. The term glittering materials as used herein refers to materials that glitter and change in color like metals or pearls, and reflect light on their surface. Glittering materials are sometimes also called “lame”.

In the second example, the glittering materials 328 are dispersed randomly, and further, the glittering materials 328 are oriented randomly. This provides the surface of the attachment piece 320 with a unique random pattern. The random pattern is coarser than the random pattern formed by paper fibers, and can be imaged at a resolution of about 200 dpi.

In the second example as well, an image of the random pattern formed on the surface of the attachment piece 320 is captured by the first imaging apparatus 30 described later. The captured image, which represents an example of feature data distributed on the surface of the paper 300, is acquired as first registration data described later and also as first identification data described later.

As described above, in the second example, the glittering materials 328 are dispersed and oriented randomly. This makes it difficult to duplicate (counterfeit) the attachment piece 320 while reproducing the dispersion and orientation of the glittering materials 328. As described above, the attachment piece including the glittering materials 328 dispersed therein has high counterfeit-resistance.

In the second example, an image of the random pattern formed by the irregularities of paper fibers on the surface of the paper body 310 is captured by the second imaging apparatus 32 described later. The captured image is acquired as second registration data described later, and also as second identification data described later.

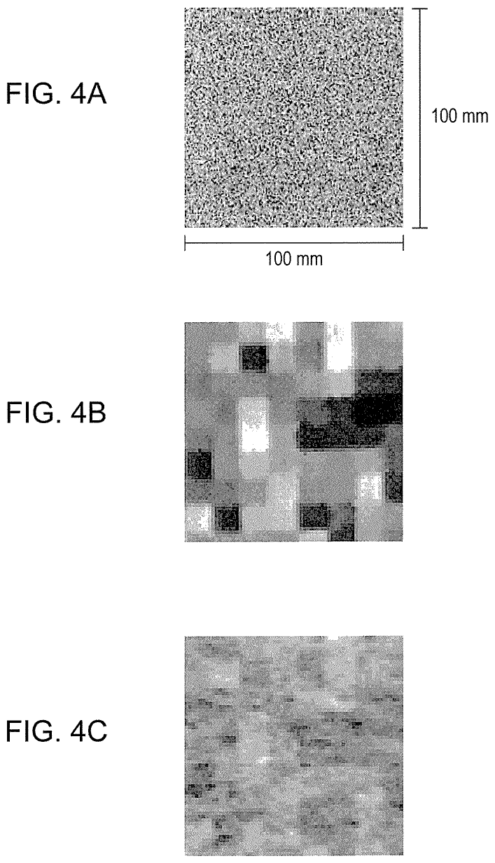

FIGS. 4A to 4C illustrate a third example of the attachment piece 320 attached onto the paper 300 representing a third example of an object to be identified. Although the paper 300 according to the third example is also provided with the attachment piece 320 attached on the paper body 310 as with the first example mentioned above, the attachment piece 320 differs in configuration from the attachment piece 320 according to the first example.

As illustrated in FIG. 4A, the attachment piece 320 according to the third example is formed by a sheet of paper provided with a random pattern that is coarser than the random pattern formed by paper fibers, such that the state thereof can be imaged on the paper fibers. The coarse random pattern needs to be formed by a method that allows an image to be formed without crushing the irregularities of the paper fibers out. For example, the coarse random patter can be formed by using an inkjet printer. In the third example, the attachment piece 320 is a square measuring 100 mm in length and 100 mm in width.

FIG. 4B illustrates an image of a specific region of the attachment piece 320 according to the third example captured with, for example, the first imaging apparatus 30 described later at a resolution of 200 dpi. It is appreciated from FIG. 4B that the captured image includes a random pattern produced by forming an image. The random pattern, which represents as an example of feature data distributed on the surface of the paper 300, is acquired as first registration data described later and also as first identification data described later.

FIG. 4C illustrates an image of a specific region of the attachment piece 320 according to the third example captured with, for example, the second imaging apparatus 32 described later at a resolution of 600 dpi. It is appreciated from FIG. 4C that the captured image includes a random pattern formed by the irregularities of paper fibers. The random pattern, which represents as an example of feature data distributed on the surface of the paper 300, is acquired as second registration data described later and also as second identification data described later.

As described above, rather than including only a coarse random pattern, the attachment piece 320 according to the third example includes a fine random pattern formed by the irregularities of paper fibers, and a coarse random pattern produced by forming an image. Consequently, the attachment piece 320 according to the third example may be used not only by being attached onto an object having a single random pattern on its surface, for example, the paper body 310, but also by being attached onto an object having no random pattern on its surface.

A fourth example of the attachment piece 320 is a printed material (not illustrated) with a unique random pattern printed thereon with a high level of lightness higher than or equal to a first predetermined value or with a low level of lightness lower than or equal to a second predetermined value. In the fourth example, this random pattern is formed to be coarser than a random pattern formed by the irregularities of the paper fibers of the paper body 310, and can be imaged at a resolution of, for example, 200 dpi. Since the random pattern is formed with high or low level of lightness, due to the small dynamic range of shades therein, the random pattern is hard to reproduce by copying. As described above, the attachment piece 320 is difficult to duplicate (counterfeit), and thus has some counterfeit-resistance.

Desirably, the random pattern on the paper body 310 is, for example, 42 μm or less (600 dpi or more). Examples of such paper include plain paper and Japanese paper. Instead of the paper body 310, an object other than paper and having a random pattern of 42 μm or less may be used.

As the first value mentioned above, for example, a value corresponding to a level of shade within the top 20% of the entire tonal range (e.g., 205 in the case of 8-bit grayscale images) can be used. As the second value mentioned above, for example, a value corresponding to a level of shade within the bottom 20% of the entire tonal range (e.g., 51 in the case of 8-bit grayscale images) can be used.

A random pattern on a printed material, which represents the fourth example of the attachment piece 320, can be created as follows. First, for example, the surface of an object having a fine random pattern, such as a solid silver coating, is scanned at a high resolution of about 800 dpi, and the scanned image is converted to a lower resolution in the range of about 100 dpi to 300 dpi to create a coarse random pattern.

As a random pattern on a printed material, a scanned image of the surface of an object with a coarse random pattern, such as wood or stone, can be used. Alternatively, such a random pattern may be an image output by using a random-pattern generation algorithm. Alternatively, white noise data may be used as a random pattern on a printed material.

Desirably, the fineness of a random pattern on a printed material is such that when printed, the random pattern has a spatial frequency (peak power value) of, for example, 10 (cycles/mm) (period: 100 μm, 508 dpi).

In the fourth example, an image of a random pattern printed on a printed material is captured by the first imaging apparatus 30 described later. The captured image, which represents an example of feature data distributed on the surface of the paper 300, is acquired as first registration data described later and also as first identification data described later.

In the fourth example as well, an image of a random pattern formed by the irregularities of paper fibers on the surface of the paper body 310 is captured by the second imaging apparatus 32 described later, and is acquired as second identification data described later and also as second identification data described later.

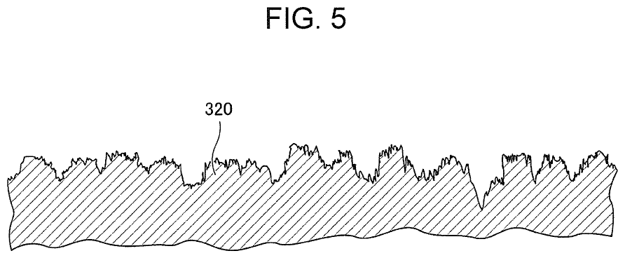

FIG. 5 illustrates a cross-section of a fifth example of the attachment piece 320 attached onto the paper 300 representing a fifth example of an object to be identified. Although the paper 300 according to the fifth example is also provided with the attachment piece 320 attached on the paper body 310 as with the first example described above, the attachment piece 320 differs in configuration from the attachment piece 320 according to the first example.

As illustrated in FIG. 5, the attachment piece 320 according to the fifth example has, on its surface, two unique random patterns that differ in their fineness. More specifically, the attachment piece 320 according to the fifth example is provided with both a low-frequency random pattern and a high-frequency random pattern. Each random pattern may be irregularities (three-dimensional structures) on the surface of an object, or may be shade information. A specific example of the attachment piece 320 according to the fifth example may be an object whose surface is provided with first irregularities that can be read with a resolution of about 200 dpi, and second irregularities that can be read with a resolution of about 800 dpi.

There are many objects in nature that have such two unique random patterns with different degrees of fineness. One such example is wood. The shades of gray due to the annual rings in wood define form a unique, long-period random pattern, and ells in wood (vessels and tracheids with thicknesses on the order of about several tens μm) define a unique, short-period random pattern.

In the fifth example, an image of a long-period random pattern on the attachment piece 320 is captured by the first imaging apparatus 30 described later. The captured image, which represents an example of feature data distributed on the surface of the paper 300, is acquired as first registration data described later and also as first identification data described later. Further, in the fifth example, an image of a short-period random pattern on the attachment piece 320 is captured by the second imaging apparatus 32 described later. The captured image, which represents an example of feature data distributed on the surface of the paper 300, is acquired as second registration data described later and also as second identification data described later.

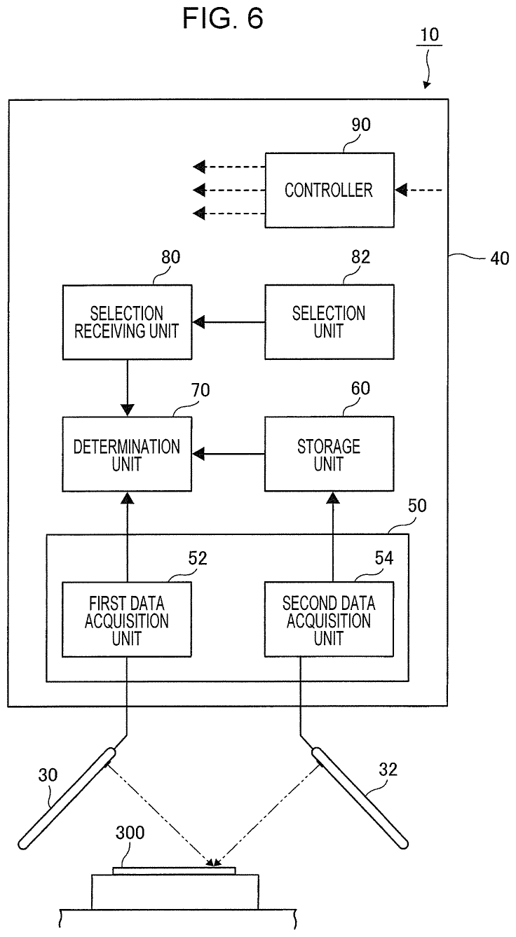

Next, a registration and identification system 10 according to a second exemplary embodiment of the present disclosure will be described below with reference to FIG. 6. As illustrated in FIG. 6, the registration and identification system 10 includes the first imaging apparatus 30, the second imaging apparatus 32, and a registration and identification apparatus 40.

As the first imaging apparatus 30, for example, a portable terminal apparatus such as a smartphone can be used. The first imaging apparatus captures a first image including the paper 300, which represents an example of an object to be registered as well as an example of an object to be identified. The first image is an image that is coarser and of lower resolution than a second image described later. For example, the first image has a resolution of 200 dpi. Accordingly, in capturing the first image with the first imaging apparatus 30, an adapter for securing the first imaging apparatus in place, an accessory having an optical system such as a lens, or other such components are not required.

As for the second imaging apparatus 32, as with the first imaging apparatus, for example, a portable terminal apparatus such as a smartphone can be used. The second imaging apparatus captures a second image including the paper 300, which represents an example of an object to be registered as well as an example of an object to be identified. The second image is an image that is finer and of higher resolution than the first image. For example, the second image has a resolution of 800 dpi. Accordingly, in capturing the second image with the second imaging apparatus 32, it is desirable to use components such as an adapter for securing the second imaging apparatus 32 in place, and an accessory having an optical system such as a lens. The first imaging apparatus 30 on which an accessory for increasing lens resolution is attached may serve as the second imaging apparatus 32. If an accessory is attached as described above, identification information indicative of an image captured with the second imaging apparatus 32 is added to image data, and the resulting data is transmitted to the registration and identification apparatus 40 described later.

Instead of using a portable terminal as the first imaging apparatus 30 or the second imaging apparatus 32, for example, a dedicated camera of, for example, a stationary type may be used.

The registration and identification apparatus 40 represents an example of a data acquisition apparatus that acquires data from a first image and a second image. The registration/identification apparatus 40 also represents an example of an identification apparatus that identifies an object by use of the first image and the second image. The registration and identification apparatus 40 includes a data acquisition unit 50, a storage unit 60, a determination unit 70, a selection receiving unit 80, a selection unit 82, and a controller 90.

The data acquisition unit 50 represents an example of an acquirer. The data acquisition unit 50 includes a first data acquisition unit 52, and a second data acquisition unit 54. The first data acquisition unit 52 acquires, from a first image captured by the first imaging apparatus 30, feature data representing features distributed on the surface of the paper 300. The acquired feature data serves as first registration data or first identification data. The second data acquisition unit 54 acquires, from a second image captured by the second imaging apparatus 32, feature data representing features distributed on the surface of the paper 300. The acquired feature data serves as second registration data or second identification data. Whether acquired data is first registration data or first identification data, or is second registration data or second identification data can be recognized as follows.

That is, at the time of image acquisition, additional information indicative of resolution is acquired additionally. If the resolution obtained from the additional information is less than a predetermined threshold, the acquired data is recognized to be first registration data or first identification data, and if the resolution is greater than the predetermined threshold, the acquired image data is recognized to be second registration data or second identification data. The additional information may be indicative of imaging apparatus type (such as camera or smartphone). In this case, the acquired data may be recognized to be first registration data or first identification data if the type of the imaging apparatus used corresponds to a predetermined type (e.g., smartphone), and otherwise the acquired data may be recognized to be second registration data or second identification data. Further, the additional information may be a flag indicative of a low resolution selected by the user. If such a flag is included, the acquired data is recognized to be first registration data or first identification data. With the registration and identification apparatus described later, the inclusion of such additional information indicative of first registration data or first identification data allows for easier determination of whether first registration data or first identification data has been selected, or second registration data or second identification data has been selected. If no such flag is included, such a determination is performed in a normal manner.

The registration and identification apparatus 40 further includes the storage unit 60. The storage unit 60 represents an example of a storage. In the storage unit 60, first registration data and second registration data acquired from the data acquisition unit 50 are stored in association with each other as data used for determining the identity of an object to be identified, such as the paper 300.

The association between first registration data and second registration data may be made in a software manner or may be made in a hardware manner. In one example, the association between first registration data and second registration data may be made as follows. The number of image captures made by the first imaging apparatus 30 and the number of image captures made by the second imaging apparatus 32 are counted from the beginning such that the two numbers are the same at all times, and first registration data and second registration data that have been captured the same number of times respectively by the first imaging apparatus and the second imaging apparatus are associated with each other.

In another example, the association between first registration data and second registration data may be made as follows. The interval of time between an image capture by the first imaging apparatus 30 and an image capture by the second imaging apparatus 32 (the interval of time between shutter releases) is set to a fixed value, and first registration data and second registration data are associated with each other based on the interval of time.

In another example, the association between first registration data and second registration data may be made as follows. The paper 300 is assigned an ID number for identifying the paper 300, and an image of the ID number is captured by both the first imaging apparatus 30 and the second imaging apparatus 32. First registration data and second registration data containing the same captured ID are associated with each other.

The determination unit 70 represents an example of a determiner. The determination unit 70 compares first identification data acquired by the data acquisition unit 50 with first registration data acquired prior to a determination and previously stored in the storage unit 60. The determination unit 70 also compares second identification data acquired by the data acquisition unit 50 with second registration data acquired prior to a determination and previously stored in the storage unit 60. Then, the determination unit 70 determines whether an object from which the first registration data and the second registration data have been acquired and stored in advance in the storage unit 60 is the same object from which the first identification data and the second identification data have been acquired.

More specifically, the determination unit 70 determines that an object from which registration data has been acquired and stored in advance, and an object to be identified from which identification data has been acquired are identical to each other in cases including if a correlation between first registration data and first identification data calculated by a predetermined program satisfies a predetermined criterion, or if a correlation between second registration data and second identification data calculated by a predetermined program satisfies a predetermined criterion.

Multiple modes can be used for the determination unit 70 to determine whether an object from which identification data has been acquired is the same object from which registration data has been acquired. Such multiple modes of determination will be described later.

The selection unit 82 represents an example of a selector. The selection unit 82 is operated to select whether to use first registration data and first identification data in identifying an object to be identified, or to use second registration data and second identification data in identifying an object to be identified.

The selection unit is operated to select the mode in which to determine whether an object from which identification data has been acquired is the same object from which registration data has been acquired. As the selection unit 82, for example, a touch panel can be used.

The selection receiving unit 80 receives a selection made by the operator by operating the selection unit 82.

The controller 90 receives an output from the selection receiving unit 80. The data acquisition unit 50, the storage unit 60, and the determination unit 70 are controlled based on an output from the controller 90.

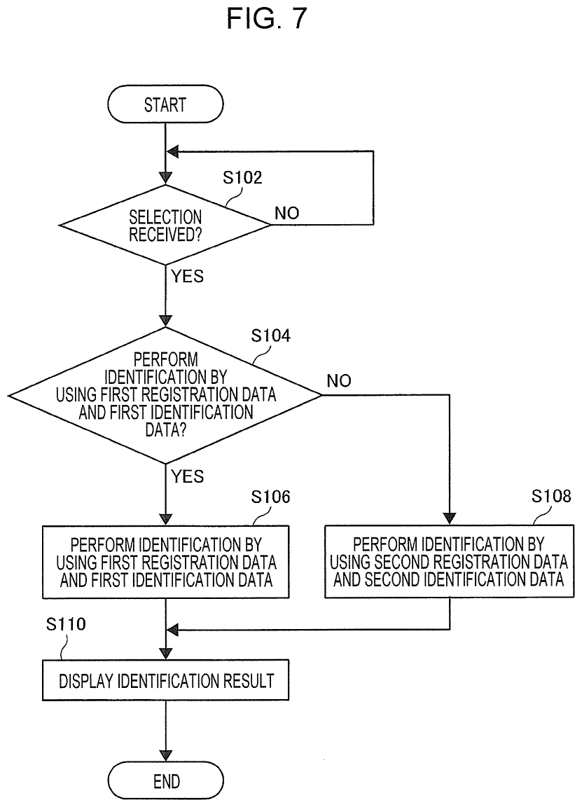

FIG. 7 is a flowchart illustrating a first mode in which the registration and identification system 10 performs identification. The following description assumes that, prior to performing identification, the first registration data and second registration data of an object to be identified are stored into the storage unit in advance. The first mode starts in response to the selection receiving unit 80 receiving a selection to perform identification in the first mode.

As illustrated in FIG. 7, first, at step S102, the selection receiving unit 80 receives an output indicative of whether to perform identification by use of first registration data and first identification data or to perform identification by use of second registration data and second registration data. The process then proceeds to step S104, which is the next step.

At step S104, the controller 90 determines whether a selection to perform identification by use of first registration data and first identification data has been made. If it is determined that a selection to perform identification by use of first registration data and first identification data has been made, the process proceeds to step S106. If it is determined that a selection to perform identification by use of first registration data and first identification data has not been made, in other words, if it is determined that a selection to perform identification by use of second registration data and second identification data has been made, the process proceeds to step S108.

At step S106, the determination unit 70 compares first registration data stored in the storage unit with first identification data acquired by the data acquisition unit 50 to thereby identify whether an object from which the first registration data has been acquired in advance, and an object from which the first identification data has been acquired by the data acquisition unit 50 are the same object.

Specifically, in the determination unit 70, a correlation between first registration data and first identification data is calculated by a predetermined program. If the calculated correlation satisfies a predetermined criterion, the determination unit 70 determines that an object from which the first registration data has been acquired in advance, and an object from which the first identification data has been acquired by the data acquisition unit 50 are the same object. If the calculated correlation does not satisfy the predetermined criterion, the determination unit 70 determines that an object from which the first registration data has been acquired in advance, and an object from which the first identification data has been acquired by the data acquisition unit 50 are not the same object.

Upon completion of step S106, the process proceeds to step S110.

At step S108, the determination unit 70 compares second registration data stored in the storage unit with second identification data acquired by the data acquisition unit 50 to thereby identify whether an object from which the second registration data has been acquired in advance, and an object from which the second identification data has been acquired by the data acquisition unit 50 are the same object.

Specifically, in the determination unit 70, a correlation between second registration data and second identification data is calculated by a predetermined program. If the calculated correlation satisfies a predetermined criterion, the determination unit 70 determines that an object from which the second registration data has been acquired in advance, and an object from which the second identification data has been acquired by the data acquisition unit 50 are the same object. If the calculated correlation does not satisfy the predetermined criterion, the determination unit 70 determines that an object from which the second registration data has been acquired in advance, and an object from which the second identification data has been acquired by the data acquisition unit 50 are not the same object.

Upon completion of step S108, the process proceeds to step S110.

At step S110, the controller 90 controls a display device (not illustrated) so as to display the result of identification on the display device. At this time, even if identification data and registration data are determined to have been acquired from the same object, different pieces of information are output depending on whether the determination has been made by using first identification data and first registration data or the determination has been made by using second identification data and second registration data. For example, if the determination has been made by using first identification data and first registration data, an indication is displayed to indicate that the reliability of the determination is lower than when the determination is made by using second identification data and second registration data. In addition to an indication of identicalness, accuracy rate or error rate may be displayed. Further, an indication may be displayed that prompts for identification to be performed by using second identification data and second registration data in order to increase reliability.

As described above, the first mode allows selection between whether to perform identification by use of first registration data and first identification data or to perform identification by use of second registration data and second identification data acquired from a fine image. Consequently, by selecting to perform identification by use of first registration data and first identification data, for example, identification using second registration data and second identification data may be omitted. This may reduce the time required for identification. Further, by selecting to perform identification by use of second registration data and second identification data, identification using a fine image may be performed. This may enhance the accuracy of identification in comparison with identification performed by using an image with a lower degree of fineness.

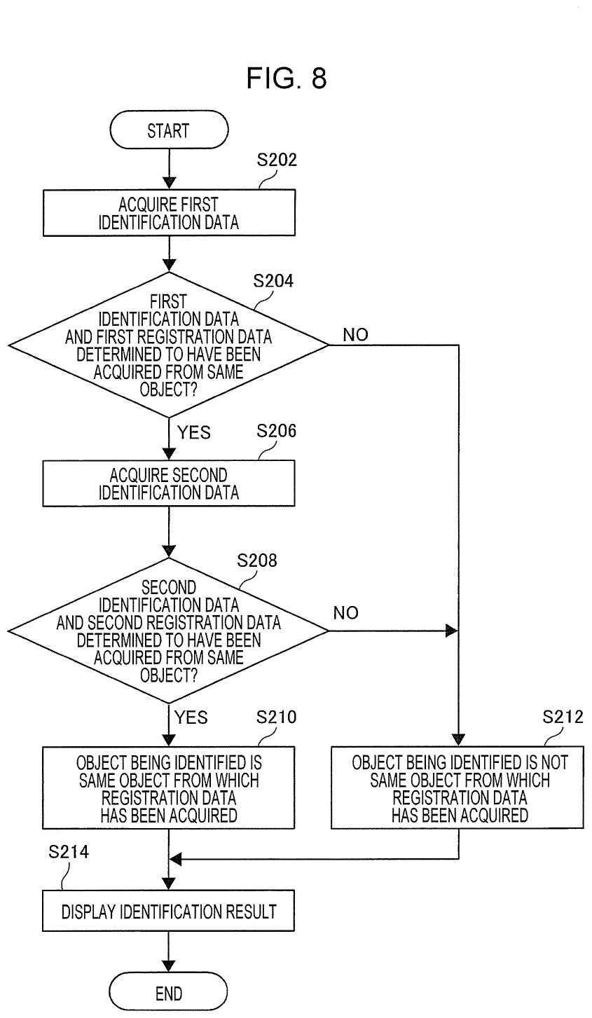

FIG. 8 is a flowchart illustrating a second mode in which the registration and identification system 10 performs identification. The following description assumes that, prior to performing identification, the first registration data and second registration data of an object to be identified are stored into the storage unit in advance. The second mode starts in response to the selection receiving unit 80 receiving a selection to perform identification in the second mode.

As illustrated in FIG. 8, first, at step S202, the controller 90 causes the data acquisition unit 50 to acquire first identification data.

Then, at step S204, which is the next step, the determination unit 70 compares first registration data stored in the storage unit with the first identification data acquired by the data acquisition unit 50, and calculates, for example, a correlation between the first registration data and the first identification data. In this way, the determination unit 70 identifies whether an object from which the first registration data has been acquired in advance, and an object to be identified from which the first identification data has been acquired by the data acquisition unit 50 are the same object.

Then, if it is determined that the object from which the first registration data has been acquired in advance, and the object from which the first identification data has been acquired are the same object, the process proceeds to S206. If it is determined that the object from which the first registration data has been acquired in advance, and the object from which the first identification data has been acquired are not the same object, the process proceeds to S212.

At step S206, the controller 90 causes the data acquisition unit 50 to acquire second identification data. The process then proceeds to step S208.

At step S208, the determination unit 70 compares second registration data stored in the storage unit 60 with the second identification data acquired by the data acquisition unit 50, and calculates, for example, a correlation between the second registration data and the second identification data. In this way, the determination unit 70 identifies whether an object from which the second registration data has been acquired in advance, and an object to be identified from which the second identification data has been acquired by the data acquisition unit 50 are the same object.

Then, if it is determined that the object from which the second registration data has been acquired in advance, and the object from which the second identification data has been acquired are the same object, the process proceeds to S210. If it is determined that the object from which the second registration data has been acquired in advance, and the object from which the second identification data has been acquired are not the same object, the process proceeds to S212.

At step S210, a final determination is made that the object to be identified is the same object from which the registration data (the first registration data or the second registration data) has been acquired and stored in advance. The process then proceeds to step S214.

At step S212, a final determination is made that the object to be identified is not the same object from which the registration data (the first registration data or the second registration data) has been acquired and stored in advance. The process then proceeds to step S214.

At step S214, the controller 90 controls the display device (not illustrated) so as to display the result of identification on the display device.

As described above, in the second mode, if a final determination is made through identification using first registration data and first identification data that an object to be identified is not the same object from which the first registration data has been acquired in advance, then a final determination is made that the object to be identified is not the same object from which the first registration data has been registered in advance, without performing identification using second registration data and second identification data. This reduces the time required for a final determination to be completed. If it is determined through identification using first registration data and first identification data that an object to be identified is the same object from which the registration data has been registered in advance, identification using second registration data and second identification data is further performed to increase the final accuracy of identification.

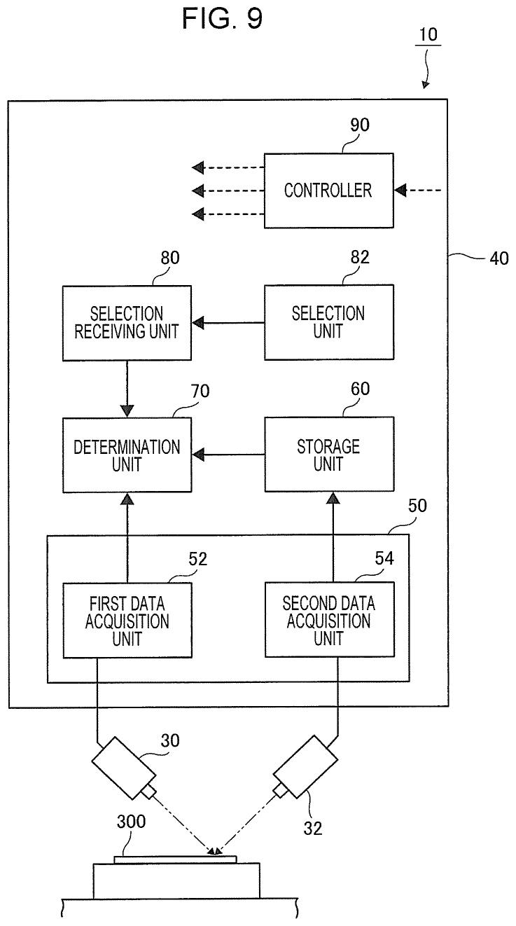

FIG. 9 illustrates the registration and identification system 10 according to a second exemplary embodiment of the present disclosure. In the first exemplary embodiment described above, the registration and identification system 10 includes the first imaging apparatus 30, the second imaging apparatus 32, and the registration and identification apparatus 40. In the second exemplary embodiment described below, the registration and identification system 10 includes the registration and identification apparatus 40, and the registration and identification apparatus 40 includes the first imaging apparatus 30 and the second imaging apparatus 32.

Although the foregoing description is directed to the case in which the paper 300 is used as an object to be registered and identified, the present disclosure is also applicable to a case in which an object to be registered and identified is an object other than the paper 300, such as an ID card or a card key.

Although the foregoing description is directed to the case in which an object used as an object to be registered and identified is the paper 300 with the attachment piece 320 attached on the paper body 310 including a unique random pattern, the present disclosure is also applicable to a case in which an object used as an object to be registered and identified is an object with an attachment piece attached on the object's body not including a unique random pattern. In this case, for example, a second attachment piece made of, for example, a sheet of paper provided with a unique random pattern may be further attached onto the object's body.

The foregoing description is directed to the case in which the identity of an object to be identified is determined by using first registration data and first identification data, and second registration data and second identification data acquired from an image finer than the image from which the first registration data and the first identification data are acquired. Alternatively, the identify of an object to be identified may be determined by using three or more pairs of registration data and identification data acquired from images with different degrees of fineness, such as by additionally using third registration data and third identification data acquired from an image finer than the image from which second registration data and second identification data are acquired.

In the case of identifying an object to be identified by use of three data pairs with different degrees of fineness, the following data pairs can be used to determine the identity of the object to be identified: a data pair acquired from a coarse image having a resolution of, for example, about 200 dpi; a data pair acquired from an image having a medium degree of fineness with a resolution of, for example, about 300 dpi to 800 dpi; and a data pair acquired from an image having a high degree of fineness with a resolution of, for example, about 900 dpi to 20000 dpi.

A case is considered in which three data pairs with different degrees of fineness are used as mentioned above and the corresponding images are captured by a portable terminal. In this case, an image with a resolution of about 200 dpi can be captured without using an adapter for the portable terminal. However, to capture an image with a resolution of about 600 dpi or greater, it is generally required to attach an adapter for positioning the portable terminal in place. Further, to capture an image with a resolution of about 900 dpi or greater, it is generally required to attach an adapter including an optical system such as a lens.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An identification system comprising:
a first imaging apparatus that captures a first image including an object to be identified;
a second imaging apparatus that captures a second image including an object to be identified, the second image being finer than the first image; and
an identification apparatus that identifies an object by use of the first image and the second image,
wherein the identification apparatus includes
an acquirer that acquires first identification data and second identification data, the first identification data being feature data representing a feature distributed on a surface of the object, the first identification data being acquired from the first image captured by the first imaging apparatus, the second identification data being feature data representing a feature distributed on a surface of the object, the second identification data being acquired from the second image captured by the second imaging apparatus, and
a storage controller that causes the first identification data and the second identification data acquired by the acquirer to be stored in association with each other.

2. The identification system according to claim 1,
wherein the acquirer acquires identification information indicative of the first identification data or indicative of the second identification data.

3. The identification system according to claim 2,
wherein if an accessory used to change fineness is attached to the first imaging apparatus, the acquirer acquires identification information indicative of the second identification data.

4. The identification system according to claim 1, further comprising
a determiner that determines an identity of an object to be identified, the identity being determined by comparing the first identification data not with second registration data but with first registration data and by comparing the second identification data not with the first registration data but with the second registration data, the first registration data being previously acquired by the first imaging apparatus, the second registration data being previously acquired by the second imaging apparatus.

5. The identification system according to claim 4,
wherein the determiner calculates a first correlation and a second correlation, and if the first correlation and the second correlation both satisfy a predetermined criterion, the determiner identifies that an object to be identified is identical to an object from which the first registration data and the second registration data have been acquired, the first correlation representing a correlation between the first registration data and the first identification data, the second correlation representing a correlation between the second registration data and the second identification data.

6. The identification system according to claim 1, further comprising
a selector that is operated to make a selection, the selection being a selection of whether an identity of an object to be identified is to be determined based on a comparison between the first identification data acquired by the acquirer and first registration data, or an identity of an object to be identified is to be determined based on a comparison between the second identification data acquired by the acquirer and second registration data, the first registration data being pre-registered data acquired from an authentic object, the second registration data being pre-registered data acquired from an authentic object.

7. An identification system comprising:
an obtaining unit that obtains first data or second data, the first data including a feature of a first image of an object to be identified, the second data including a feature of a second image, the second image being finer than the first image; and
an output unit that, if an object to be identified is determined to be identical to an authentic object by using the first data or second data obtained by the obtaining unit and by using registration data previously acquired from the authentic object, outputs information that differs depending on whether the obtaining unit has obtained the first data or has obtained the second data.

8. The identification system according to claim 7,
wherein if the first data is used, the output unit outputs information indicative of identicalness but low accuracy.

9. The identification system according to claim 8, further comprising
a receiving unit that receives an instruction, the instruction being an instruction as to whether to perform a determination using the first data or to perform a determination using the second data.

10. An identification apparatus comprising:
an acquirer that acquires first identification data from a first image, and acquires second identification from a second image finer than the first image, the first image being captured by a first imaging apparatus and including an object to be identified, the first identification data being feature data representing a feature distributed on a surface of the object, the second image being captured by a second imaging apparatus and including an object to be identified, the second identification data being feature data representing a feature distributed on a surface of the object; and
a storage controller that causes the first identification data and the second identification data acquired by the acquirer to be stored in association with each other.
